(19) United States
(12) Patent Application Publication
(10) Pub. No.: US 2006/0218005 A1
(43) Pub. Date: Sep. 28, 2006

(54) Computerized agent and systems for automatic searching of properties having favorable attributes

(76) Inventors: Jose A. Villena, Miami, FL (US); Mario A. Villena, Miami, FL (US); Robert A. Villena, Miami, FL (US); Manuel J. Iraola, Coral Gables, FL (US); William P. Kennedy, Pembroke Pines, FL (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/432,515

(22) Filed: May 12, 2006

Related U.S. Application Data
(63) Continuation-in-part of application No. 10/536,693.

(51) Int. Cl. G06Q 99/00

(52) U.S. Cl. 705/1

(57) ABSTRACT

An electronic agent for performing property-related searches and notifications based on search parameters provided by a user includes a first device configured to receive information about residential properties and a second device configured to receive information from the first device about a first property determined to be offered for sale, and determine whether the first property conforms to a differential valuation. In various embodiments, the differential valuation can be based on an offering price of the first property, an AVM generated value of the first property and one or more AVM-related user-provided parameters.

This application is a Continuation-in-Part of U.S. patent Ser. No. 10/536,693 filed on May 27, 2005, which itself derives priority from international patent application PCT/US2004/28206 filed on Aug. 31, 2004.

### FIELD OF THE INVENTION

This disclosure relates to a computer-based agent for detecting property anomalies.

### BACKGROUND OF THE INVENTION

Real estate is a multi-billion dollar industry touching virtually every strata of our society. Although the industry has consolidated somewhat during the last ten years, it remains highly fragmented. Unfortunately, the “power to transact” is largely concentrated in the hands of real estate brokers and agents regardless of the fact that entry and exit barriers are low. Further, the range of available buying and selling options are limited since the services provided by practically every real estate professional are virtually the same throughout the entirety of the United States and beyond.

Unfortunately, the real-estate industry has been highly resistant to the threat of new and potentially disruptive technologies as consumer behavior have been almost completely ignored. While a number of new computer-based tools are under development or have been proposed, their effect has either been inconsequential or specifically designed to preserve the status quo of the real estate industry, rather than directed to transform the industry to the benefit of property owners. Accordingly, new technological approaches relating to real estate are desirable.

### SUMMARY OF THE INVENTION

In one aspect, an electronic agent for performing property-related searches and notifications based on search parameters provided by a user includes a first device configured to receive information about residential properties and a second device configured to receive information from the first device about a first property determined to be offered for sale, and determine whether the first property conforms to a differential valuation. In various embodiments, the differential valuation can be based on an offering price of the first property, an AVM generated value of the first property and one or more AVM-related user-provided parameters.

In another aspect, an electronic agent for performing property-related searches and notifications based on search parameters provided by a user includes an AVM database containing AVM-generated values for substantially every residential property in a definable geographic region, a first device configured to receive information about residential properties as they are initially offered for sale and a second device configured to notify the user based on user-provided parameters, the offering price of the first property and at least one AVM entry in the AVM database.

In yet another aspect, an apparatus for predicting the sale date of a property includes a memory containing information about an identified property, the information including: an AVM-generated value of the identified property and the offering price of the identified property. The apparatus can also include a processing device that generates a sales profile for the identified property based on the offering price and the AVM generated value, the sales profile including a likely sale date.

In still another aspect, a storage medium contains a number of instructions that when accessed by a computer can enable the computer to perform agent-related services for a user. The storage medium can include a first set of one or more instructions for receiving information about one or more first residential properties as they are initially offered for sale, and a second set of one or more instructions for determining whether the first residential properties conform to a differential valuation, the differential valuation being based on an offering price of the first property, an AVM generated value of the first property and one or more AVM-related user-provided parameters.

In yet another aspect, an Internet-based electronic agent for performing property-related searches and providing responsive information based on information provided by a consumer at a remote terminal is disclosed. The electronic agent includes a communication device configured receive selection information from the user relating to residential properties, wherein the selection information is used to identify a set of one or more properties, and a reporting device configured to display report information to the remote terminal via the Internet relating to the identified set of properties, the report information including a first AVM value for a first property of the identified set of properties, where the first AVM value is provided to the user without the user providing information to the electronic agent affecting amount of the first AVM value.

In again another aspect, a method for providing Automated Valuation Methodology (AVM) values to a consumer over the internet includes receiving selection information from a user at a remote terminal over the Internet, identifying a set of one or more properties using the selection information and reporting to the remote terminal via the Internet report information that includes a first AVM value for a first property of the identified set of properties, where the first AVM value is provided to the user without the user providing information to the electronic agent affecting the amount of the first AVM value.

In still yet another aspect, a method for enabling a consumer to receive Automated Valuation Methodology (AVM) values over the Internet includes providing selection information from a user at a terminal to a computer-based agent, wherein the computer-based agent identifies a set of one or more properties using the selection information, and receiving from the computer-based agent via the Internet report information that includes a first AVM value for a first property of the identified set of properties, where the first AVM value is provided to the user without the user providing information to the computer-based agent affecting the amount of the first AVM value.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts a networked system capable of allowing users to access AVM technology.

FIG. 2 is a block diagram of a system capable of performing AVM-related services.

FIG. 3 depicts various geographic regions of interest.

FIG. 4 depicts AVM database information.

FIG. 5 depicts a parameter-setting page.

FIG. 6 depicts a first reporting page.

FIG. 7 depicts a second reporting page.

FIG. 8 is a flowchart outlining an exemplary operation for performing AVM-related services.

FIG. 9 is a second flowchart outlining an exemplary operation for performing AVM-related services.

### DETAILED DESCRIPTION

Automated Valuation Methodology (AVM) is a computer-based technology that has been used to determine the market value of real estate for nearly a decade. Unfortunately, AVM technology is very expensive. As a result, the available AVM providers are generally limited to a very few large corporations. The downside of having such limited pool of AVM providers keeps the price extremely high and the availability extremely limited. For example, one web-based service will provide an AVM valuation of a specific residential property for $25. While this may be appropriate if one desires to look at a limited number of properties or determine a mortgage limit for a specified property, its utility as a market analysis tool to the small investor is practically nil as performing a comparative analysis of properties in even a small geographic can cost tens of thousands of dollars.

Another downfall of the limited availability of AVM providers is quality. In an study of four AVMs, Standard & Poor's found that, while known AVM can (in many circumstances) provide decent property estimates, known AVM systems are documented as over-estimating property values by as much as two-hundred percent. As a result of the spotty nature of AVMs, lenders are forced to continue to rely heavily upon appraisers, who in turn rely on what is known as the “Appraisal Institute Residential Database” (AIRD). As the AIRD is basically of use only to professional appraisers and only for specific identified properties, its usefulness as a marketing tool to the small investor is also practically nil due to the high expense of the human element.

In view of these circumstances, the inventors of the disclosed methods and systems have created an entirely new approach to empower buyers and sellers of real estate property. Against industry trends and traditions, the inventors have invested greatly in their own AVM technology, and applied it in unconventional and novel ways. Accordingly, the inventors have a unique standing in the relevant industry with the ability to perform massive numbers of AVM valuations at negligible costs. As a result, the inventors have created novel applications that can take advantage of the strengths of AVM technology while limiting their known liabilities. For example, by employing AVM technology not against various specific properties, but against practically every property in a given geographical region, entirely new approaches for investing can be formulated with negligible costs and before any substantial money is ever invested by a given consumer.

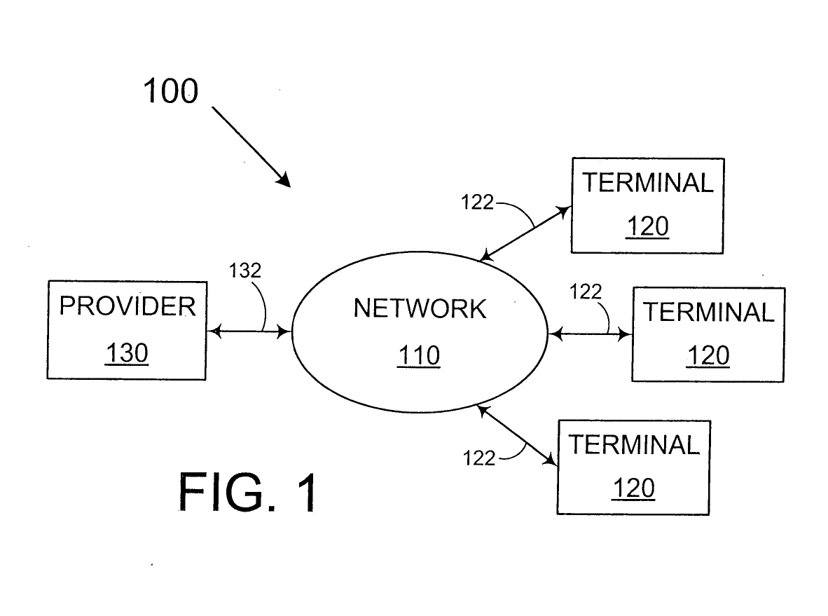

FIG. 1 depicts an exemplary networked-system 100 configured to enable individual consumers/investors to effectively utilize AVM technology. As shown in FIG. 1, the networked-system 100 includes a provider 130 coupled to a network 110 via link 132, as well as a number of terminals 120 coupled to the network 100 via respective links 122.

In operation, the provider 130 can work according to two different schemes: as an on-line tool and as an automated agent.

In operating as an on-line tool, the provider 130 can first perform a number of set-up operations, such as creating and maintaining a database of all (or substantially all) known properties in a particular geographical region, performing an AVM valuation of such properties and identifying all such properties that are offered for sale. Once the appropriate information is amassed and prepared, the provider 130 can service anyone who may desire to employ any of a number of property-related services made available by the provider 130. In the present embodiment, such services can be accessed using any of the available terminals 120.

The terminals 120 of the immediate example are personal computers capable of interfacing with a network. However, in various embodiments the terminals 120 can include any of a variety of communication devices, such as personal computers, PDAs, telephones and cell-phones (with and without graphic displays), television sets with special two-way interfaces or any other known or later-developed communication device capable of communicating with an automated service provider without departing from the spirit and scope of the present disclosure.

The exemplary provider 130 is a computer-based server capable of accessing the Internet. However, as with the terminals 120, it should be appreciated that the provider 130 can take any number of forms, such as a server, a personal computer, a mainframe and so on.

The exemplary network 110 is a publicly available portion of the Internet. However, in other embodiments the network 110 can be any viable combination of devices and systems capable of linking computer-based systems including a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

The various links 122 and 132 of the present embodiment are a combination of devices and software/firmware configured to couple computer-based systems to the Internet over a wired line. However, it should be appreciated that, in differing embodiments, the links 122 and 132 can take the forms of modems, networks interface card, serial buses, parallel busses, WAN or LAN interfaces, wireless or optical interfaces and the like as may be desired or otherwise dictated by design choice.

Returning to FIG. 1, once the provider 130 has performed the above-mentioned initial tasks, the provider 130 can then provide a variety of services to potential users via the terminals 120. In order to service such users and enable various features, the provider 130 of the present embodiment can provide a number of web-pages formatted using HTML, XML, Flash or any other viable publishing standard, such that users accessing the web-pages can do so using nothing more than a commercially available web-browser. However, it also should be appreciated that the provider 130 can also use any number of standardized or specially designed software packages as may be necessary or otherwise desired under a given set of particular circumstances. For example, users accessing the provider 130 using a telephone might use a VoiceXML interface, users accessing the provider 130 using a PDA or FAX-based interface might use a custom program and so on.

A first available service provided by the provider 130 includes the capacity to allow users to query its databases to identify and list all real properties in a given geographic region (such as a region defined by a zip-code, a state, city or county, a school zone, a housing development etc) as well as identify all known properties offered for sale in such region. The provider 130 can further perform queries to identify different types of properties (e.g., single-family dwellings, townhouses, condos, duplexes etc), identify properties based on sale price, tax valuation, number of bedrooms, number of bathrooms, acreage or any other aspect of a property that a consumer/investor might care about and that can be described on a computer medium.

Additionally, the provider 130 can perform queries and identify properties based on AVM valuation. For example, given that the provider 130 can access a database of substantially all known properties in a particular city, and given that the database contains an AVM value for each property, the provider 130 could identify all properties within the city having an AVM value between $150,000 and $100,000, identify all townhouses having an AVM value between $150,000 and $100,000 and so on.

Still further, the provider 130 can perform a “Differential Valuation Search” (DVS) to identify properties based on both their respective AVM values and sale prices. That is, a particular user may wish to identify various properties in a particular region that are offered for sale at a price substantially below their AVM values. For example, by formulating a query to include a preferred school district and an interest in townhouses that are offered for sale at a price at least 20% below their respective AVM values, the provider 130 can appropriately respond and identify any such properties with but a short wait and modest fee.

In the present embodiment, the provider 130 can identify such properties by issuing a literal list of such properties in any number of ordered ways, e.g., ascending/descending sale prices, ascending/descending AVM values, ascending/descending DVS values etc. In other embodiments, however, results can be reported using any combination of lists, graphics (e.g., maps), voiced responses (using, for example, VoiceXML technology) and so on.

In addition of a percentage-based DVS query, the provider 130 can also perform DVS queries based on the absolute difference in sale price and AVM value. Still further, DVS queries can be formed based on a “modified absolute difference” in sale price and AVM value, i.e., the absolute difference discounting various financial factors, such as condo fees, insurance rates, tax assessments, reported utility rates or any other known or later acknowledged item that can affect the investment value of a property. For instance, while a particular user may wish to identify all single-family dwellings in a city that are for sale for at least $10,000 below their AVM value, the user may desire to discount, change the ordering of, highlight or completely eliminate properties that might pass the differential valuation requirement but are encumbered by housing association fees, unusual insurance requirements, reside in high-crime neighborhoods and so on.

Another optional feature of the provider 130 is its ability to perform AVM or DVS searches on dissimilar properties to compare unlike properties for value. For example, a user may wish to identify all condos of a specific type (e.g., 2 bedrooms, 2 bathrooms and 1200+sq ft) in a specific price range with a DVS of 20% simultaneously with all single-family dwellings of a given DVS (or AVM) range having at least three bedrooms and located on at least two acres. By allowing such complex queries, the provider 130 can issue important financial data to investors thus allowing them to compare and contrast various investment opportunities, as well as present attractive options to potential buyers more interested in living in one of several types of (well-priced) properties than investing merely for profit.

While it should be apparent to one of ordinary skill in the art that the descriptions and discussions in this disclosure apply to the existing housing market, as opposed to the new housing market, it might be appreciated that many of the disclosed methods and systems can equally apply to the new housing market—particularly in comparing the embedded value of new housing sales to the value of existing homes. For example, supposing that a developer is selling a dozen new properties located in an established neighborhood. A consumer, using the disclosed methods and systems can compare each sale property against a respective AVM value as well as against the AVM and last sale value of the surrounding houses.

As mentioned above, the provider 130 can work according to two different schemes: as an on-line tool and as an automated agent. Further disclosure about on-line operations can be found in U.S. patent application Ser. No. 10/563,691 filed on May 27, 2005 to Mario Villena and Jose Villena entitled “COMPUTERIZED SYSTEMS FOR AUTOMATIC EVALUATION OF REAL ESTATE HAVING VARIOUS OPTIONAL SPECIALIZED COMMUNICATIONS INTERFACES”, the substance of which is incorporated by reference in its entirety.

Regarding the automatic agent-mode of operation, it should first be appreciated that some or all the base functionality available in the on-line mode can be available in the agent-mode, and that some or all the base functionality described in the agent-mode can be available in the on-line mode. However, it should also be appreciated that the agent-mode includes a variety of set-up features and special interfaces that can allow a user to be notified about any desired information practically the moment such information is publicly available on the market, as well as take advantage of communication techniques that may or may not be applicable with on-line tools.

For example, in agent-mode operation or in on-line mode, a prospective user might first be required to register with the provider and/or enter some form of identification and password information to initially access the provider's utilities. Similarly, in either agent or on-line mode a user can form and submit a set of query parameters to include structural information, geographic information, AVM information and so on. However, because an agent can work independently of a user, it can be useful for an agent residing in the provider 130 to initiate contact with a user over a variety of media. For instance, assuming that an agent determines that a property meets the criteria set by particular user and the property appears markedly undervalued. Rather than wait for the user to assert communication, the agent can initiate contact with any terminal 120 accessible to the user, including terminals supporting email, instant messaging, facsimile, telephone contact/voicemail, special pop-up windows and so on. Other forms of communication available can include communication by phone, by standard mail, by telegram or any other known or later developed communication technology that can manipulated by an computer or automated agent.

In addition to using novel means to notify or initiate contact simultaneously over a number of terminals, an agent of the exemplary provider 130 can receive instructions and pass information to a user in new ways. For example, assuming that an agent has identified a particular set of properties that conform to a particular users query, the agent can send alerts/notifications simultaneously via email, pager and instant messaging. The user, responding to his pager, may make contact with the agent via a telephone and, using voice commands, can identify himself and instruct the agent to fax the information to a number presently (or previously) specified by the user as well as download a map with driving instructions to the user's wireless PDA. The agent, in turn, can electronically generate the requested fax as well as download the appropriate information to the PDA.

An advantage provided by the above-described provider/agent and interfaces is that it can be possible to decrease the chances that a particular well-priced property can go unnoticed before the opportunity is usurped by another buyer.

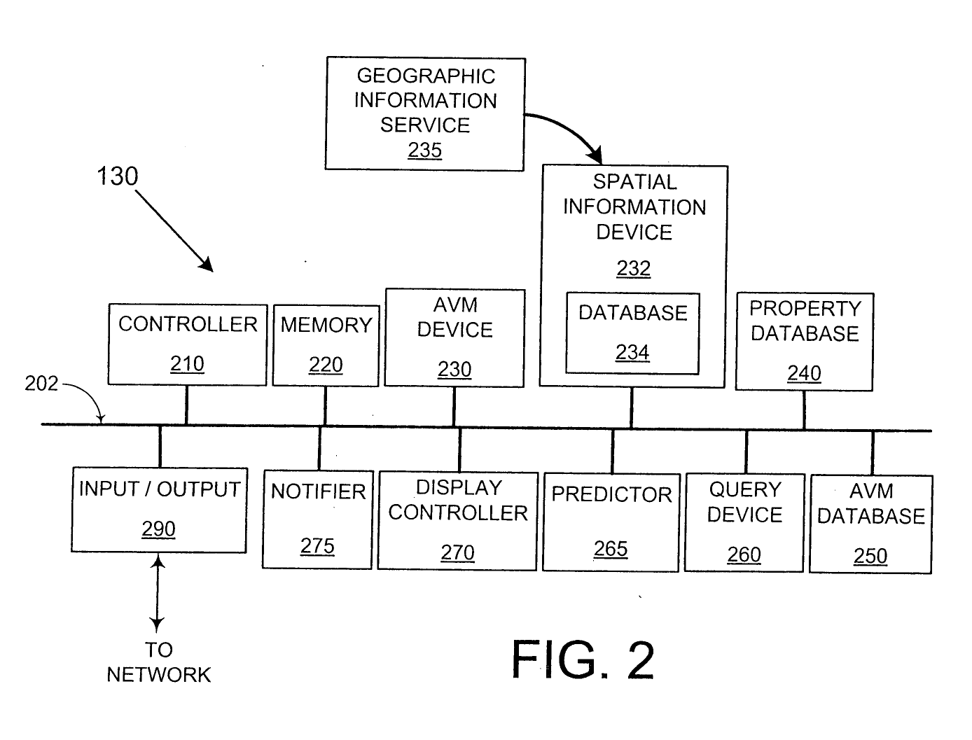

FIG. 2 is an exemplary provider 130 capable of providing a variety of agent-oriented property related services including services that use AVM technology. As shown in FIG. 2, the exemplary provider 130 includes a controller 210, a memory 220, an AVM device 230, a spatial information device 232 (with optional spatial database 234) supported by a Geographical Information Service (GIS) 235, a property database 240, an AVM database 250, a query device 260, a predictor 265, a display controller 270, a notifier 275 and an input/output device 290. The above components 210-290 are coupled together by control/data bus 202.

Although the exemplary provider 130 of FIG. 2 uses a bussed architecture, it should be appreciated that any other architecture may be used as is well known to those of ordinary skill in the art. For example, in various embodiments, the various components 210-290 can take the form of separate electronic components coupled together via a series of separate busses.

Still further, in other embodiments, one or more of the various components 210-290 can take form of separate servers coupled together via one or more networks. Additionally, it should be appreciated that each of components 210-290 advantageously can be realized using multiple computing devices employed in a cooperative fashion. For example, by employing two or more separate computing devices, e.g., servers, to provide spatial information for each computing device used to make AVM calculations, a processing bottleneck can be reduced/eliminated and the overall computing time to produce AVM valuations and other services can be drastically reduced.

It also should be appreciated that some of the above-listed components can take the form of software/firmware routines residing in memory 220 and be capable of being executed by the controller 210, or even software/firmware routines residing in separate memories in separate servers/computers being executed by different controllers. Further, it should be understood that the functions of any or all of components 230-270 can be accomplished using object-oriented software, thus increasing portability, software stability and a host of other advantages not available with non-object-oriented software.

In operation, the provider 130 can first perform a number of setup operations including populating the property database 240 with information about every property within a geographic region of interest as well as identify which properties are offered for sale and the method of sale (e.g., for sale by owner, via an agent etc). While the exemplary provider 130 uses a collection of public and private records (e.g., MLS databases, secondary databases, tax databases, newspaper ads and ads placed specifically with the provider 130) the particular sources of information can vary as required or otherwise found advantageous.

Once the property database 240 is populated, the AVM device 230, under control of the controller 210, can perform an AVM valuation on each property in the property database 240. The exemplary AVM device 230 is based on a combination of heuristic and statistical technologies. However, it should be appreciated that the particular form and functionality of the AVM device 230 can vary from embodiment to embodiment as the technology evolves or as otherwise can be found advantages in various circumstances.

In order to support the AVM device 230, the exemplary provider 130 employs its spatial information device 232 to provide high-resolution spatial data for the various properties of interest, such as high-resolution spatial data including absolute position data, relative position data (e.g., from one property to another), relative direction data etc.

The exemplary spatial information device 232 provides an advantage over conventional AVM systems in that the inventors of the present methods and systems have found a way to reliably and consistently provide absolute and relative spatial information measured in increments of feet (or meters). This is in stark contrast to conventional AVM systems which can only provide distance resolutions literally measured in miles and having negligible, if any, directional information. This is because unlike the exemplary GIS 235, which derives position information using GPS global positioning data to perform high-resolution surveys, conventional systems rely on position approximations based on township, range, section and subdivision information that may or may not be contained in property databases.

While the exemplary spatial information device 232 can provide spatial resolution down to a meter or less, it should be appreciated that more coarse resolutions may be employed with varying degrees of performance. For example, by using a resolution of ten meters, one-hundred meters, two-hundred meters, five-hundred meters and even a kilometer AVM valuation accuracies may be expected to degrade, but may still provide better performance than conventional techniques due to superior resolution, consistency and/or the availability of vector information.

While GIS is a known technology used for land use planning, transportation planning, environmental management and other uses, the exemplary methods and systems are unique in that there are no known instances where a GIS has ever been used for any form of property valuation whether it be by AVM or other means. Similarly, there are no known instances where any form of survey data (by GIS, GPS or other means) has ever been used for any form of property valuation.

In various embodiments, a Geographic Information System can be a combination of computer hardware, software, personnel, survey equipment and data that can enable one to do one or more of store, create, and analyze spatial data. Spatial data can be any information that is referenced to a location. In short, a GIS can be more than a map in that it can hold an underlying database. In order to assure consistent, reliable high-resolution spatial data, the exemplary GIS 235 derives spatial positioning information using survey data, such as survey data derived in part from GPS equipment.

By incorporating a GIS into the exemplary provider 130, a plethora of advantages over other systems are gained, including the availability of a visual representation of the geographic region under analysis. For example, the GIS of the exemplary embodiment can provide a map-like display of objects, such as parcels, schools, police stations, fire hydrants, churches etc. Another advantage to using a GIS is that the above map-like representation is more than a collection of spatially distributed symbols as each symbol/icon has a variety of information associated with it. For example, by referencing a particular “house” symbol, an operator can pull up a host of (1) geographic information, such as latitude, longitude, elevation, county, school district etc, (2) structural information, such as acreage, age, number of bedrooms etc, and various miscellaneous items of information, such as sale history, mortgage etc.

Another advantage of the exemplary system is that it has the ability to highlight on a map the comparables selected for a given target property, and the ability to highlight on a map the comparables selected for AVM valuation.

Still another advantage of the present GIS system is its ability to provide distance calculations down to meters/feet between any two objects as well as directional information. The fine resolution of distances and/or direction can provide an incredible advantage in that, the closer that two structurally comparable houses are, the more likely the sale price of one property will reflect on the value of the other property. Accordingly, the exemplary GIS system can make it possible to weight various sale values as a function of distance in a way that was never possible before.

Additionally, by using true spatial vector information (distance plus angle (or other coordinate system)), AVM calculations can be further refined. For example, if a particular house is structurally comparable to four other houses, and the four houses have values that vary (1) as a function of how far west each house lies and (2) as a function of their proximity to a river or train station, it should be appreciated that high-resolution distance information and angular information may be valuable.

Although the use of GIS (or equivalent spatial) information can be invaluable, processing such information can be relatively expensive in terms of the computation power required to derive accurate AVM valuations via GIS information. As making computationally expensive determinations is rarely acceptable in a web environment, the present AVM system overcomes this problem by pre-processing AVM valuations, preprocessing spatial information and using multiple computer systems to alleviate processing bottlenecks, then allowing users to access some or all of the preprocessed data.

Returning to FIG. 2, as each property in the property database 240 is processed and an AVM value is determined, the AVM device 230 can place the AVM data, along with other data of interest, into the AVM database 250. In the present embodiment, the exemplary AVM device 230 can update the AVM database 250 often and, in some embodiments, can update the AVM database after every sale of a property.

For example, in a particular embodiment, the controller 210 can update the property database 240 to signal that a townhouse in a particular neighborhood recently sold for a given amount of money along with other useful information about the transaction, such as concessions made by the buyer or seller (e.g., points paid by seller) that might better reflect the actual sale value of the property. The AVM device 230 can then subsequently update the AVM values of properties that might be affected by the sale, such as comparable townhouses and other properties in the immediate area, then update the AVM database 250 appropriately.

Other schemes to update AVM databases include periodic update of the entire database, periodic update of classes of properties, e.g., condos of a certain price range, or periodic update of individual properties. Further disclosure about AVM databases can be found in U.S. patent application Ser. No. 10/563,692 filed on May 27, 2005 to Mario Villena and Jose Villena entitled “COMPUTERIZED SYSTEMS FOR FORMATION AND UPDATE OF PROPERTY DATABASES”, the substance of which is incorporated by reference in its entirety.

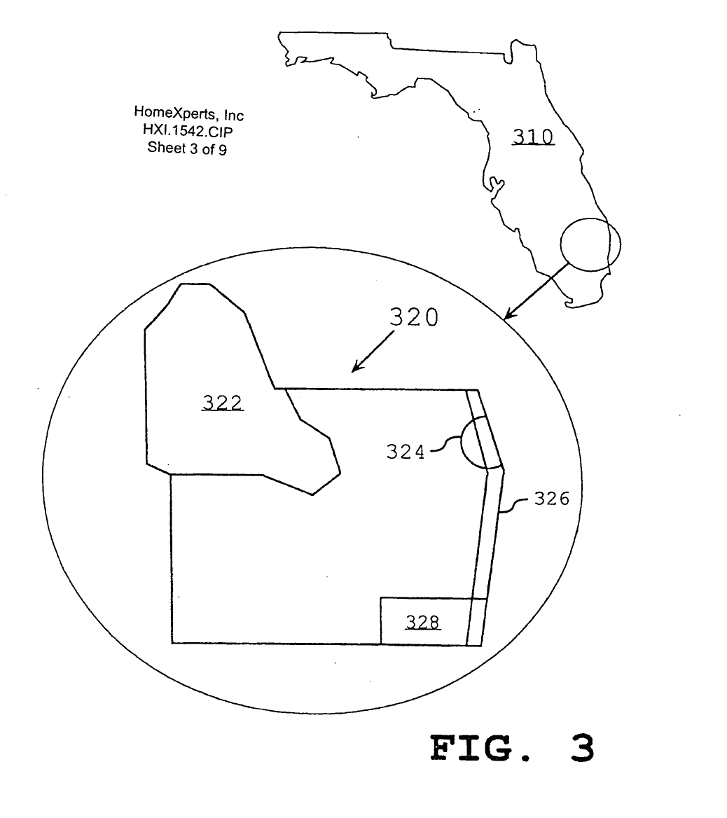

FIG. 3 depicts various types of geographical regions of interest. As shown in FIG. 3, a first region 310 (Florida) can be considered as a definable region of interest as well as a county 320 (Palm Beach). While the county may a better region to work with given its specificity, FIG. 3 shows that the county 320 can be conceptually divided into a zip-code region 322, a region of an incorporated city 324, an exemplary school district 328 or beachfront property 326. Noting that the various regions 310-328 can overlap, it should be appreciated that it can be useful to define regions by multiple, overlapping geographical attributes, e.g., beachfront property 326 found in school district 328.

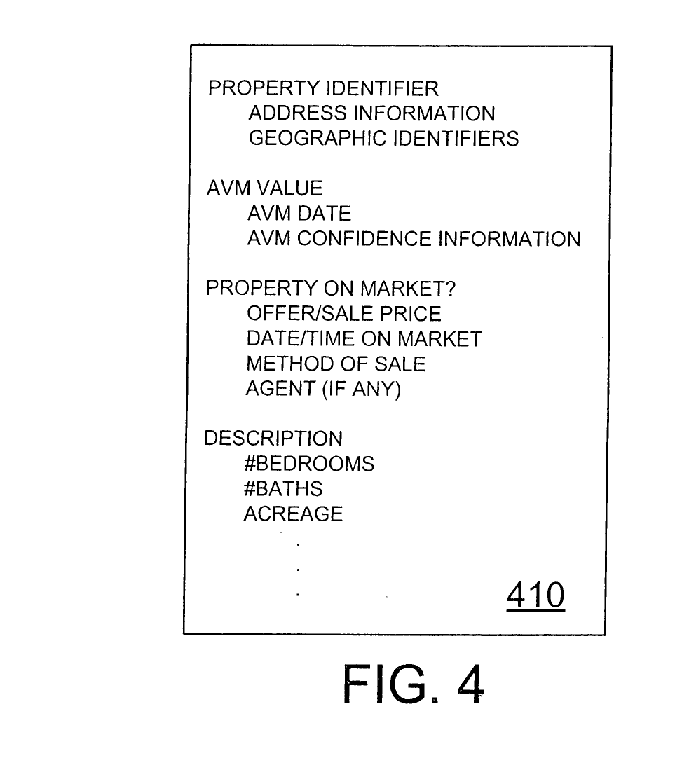

FIG. 4 depicts an exemplary entry 410 of an AVM database, such as the database 250 of FIG. 2. As depicted in FIG. 4, the exemplary entry 410 contains a variety of fields, each of which can have use in executing a query/search of real estate properties. For example, a first useful field can be a “property identifier”, which can be a unique code associated with the property at interest. Other related fields can be the address of the property (which may also serve as a property identifier) and various geographic identifiers, which can serve to provide exact geographic information (latitude and longitude), school district information, zip code, housing development information, zoning information or any other information having geographic significance. Such fields, which can define a wide range of geographic regions can add value to a database by enabling unique geographic searches.

A second group of fields includes an AVM value field, the date that the AVM value was calculated and various AVM confidence identifiers, which can provide a measure of confidence as to the accuracy of the AVM value. Such AVM confidence identifiers can include a number of similar properties on the market that have recently sold, a number of similar properties upon which an AVM value was determined and so on. Such AVM confidence identifiers may also consist of a set of one or more codes or values (e.g., a statistical variance) reflecting the above-mentioned (or similar) data.

Other information of interest can include various sale information fields, such as indicators as to whether the property is presently offered for sale, the offering/sale price, the date/time on market, the method of sale (e.g., for sale by owner, bankruptcy sale), the sales agent if any and so on. Still other information can include detailed description information of the property, such as the number of bedrooms, total square feet etc.

Again returning to FIG. 2, it should be appreciated that in view of FIGS. 3 & 4 the available data in the databases 240 and 250 can enable a filtering device, such as the query device 260, to perform AVM-based queries on any number of regions defined by attributes such as a state, a city, a set of nearby cities a county or parish, adjacent counties, a zip code, proximity to a resource (e.g., a beach) or proximity to a specific location (e.g., within a 4 block radius of a train/subway station), a school district, a particular neighborhood, adjacent neighborhoods or a set of neighborhoods, a geographic region governed by a particular government body, a set of geographic regions governed by different government bodies and so on.

It should also be appreciated that the query device 260 might also perform queries based on a geographic region provided by a user, such as a hand-drawn region provided using a computer mouse and a computer-generated map backdrop or area defined by latitude and longitude coordinates.

Still further, it should be appreciated that the query device 260 can perform queries based on certain information regarding the character of the property, such as acreage, type of property, number of bedrooms, etc.

Note that, whenever a map-like graphic representation (e.g., maps, aerial photographs showing houses, streets etc or hybrids thereof) is evoked, either by defining a geographic region by hand or by reference (e.g, identifying a zip code), the query generated can reflect every property/property for sale, and consequently the report generated can show the map-like graphic representation populated with the appropriately located icons representing the subject properties. Of course should more limitations be applied (e.g., price range, AVM value range, number of bedrooms etc) the number of properties represented may diminish.

Still further, should a user perform any number of scene changes, such as zooming-in, zooming out and panning, the underlying query can change as a function of the area immediately shown. For example, suppose that a user using a mouse initially defined a geographic region on a map of Florida to include only a suburb in South Miami of 36 square blocks, and a query produced 40 subject properties distributed randomly throughout. The user could incrementally (or in a single command) zoom in to the point of viewing a single subject property or likewise zoom out to define a region too large to provide a meaningful query. Similarly, a panning operation, e.g., incrementally displaying regions to the north, can produce different queries such that the original 40 properties will be eliminated from the query results as the properties are removed from view.

As described above for any change in view, a different query can be generated to produce a different number of subject properties—the results of which can be used to populate the instant map display with respective icons and/or produce a list of subject properties. As always, for each icon or list entry, a respective AVM value for each subject property can be included within the display—along with a whole host of other associated information found in public databases.

Further, with an action as simple as a mouse “click” on a subject property icon (or on a portion of a description window related to the subject property), comparable properties for individual subject properties may also be highlighted within a given map, and a list of details for each subject property may optionally appear.

By selecting a particular comparable property, the user can evoke any number of public records, such as an address, a tax record or sales history. Should the user desire an AVM value for a particular comparable property—or any other property for that matter—the manner upon which the user evokes the appropriate AVM value can depend on whether a preexisting AVM value is available in the AVM database 250. Should a preexisting AVM value be available, it can be a simple and efficient issue of accessing the AVM database 250 to provide the appropriate AVM value to the user.

Otherwise, the disclosed methods and systems can instantly generate an AVM value for a given property with no other action by a user required other than to identify the property and some indication that an AVM value is desired—both of which can happen with a single mouse “click”.

Note that new AVM values can be instantly generated even for subject properties having preexisting AVM values in the AVM database 250—a tool that might prove useful for instances where one or more neighboring/comparable properties has very recently sold and the appropriate public records updated, but where the sufficient resources necessary to updating the property database 240 has not yet been made available.

Using the available information provided by the AVM database 250 and the services provided by the query device 260, it should be apparent that users of the provider 130 can identify properties of interest in a large number of new and useful ways.

In the present embodiment and in either on-line or agent-mode, the provider 130 can receive various queries of interest via the input/output device 290 and the display controller 270, which is configured to provide a number of types of interface tools appropriate to the circumstances. For example, assuming that a user desires to create an agent via a web-browser on his personal computer, the display controller 270 can provide a number of appropriate web-pages. Similarly, the display controller 270 can alternatively provide any number of visual or text interfaces for PDAs or other like equipment, voice-based interfaces for phones and so on.

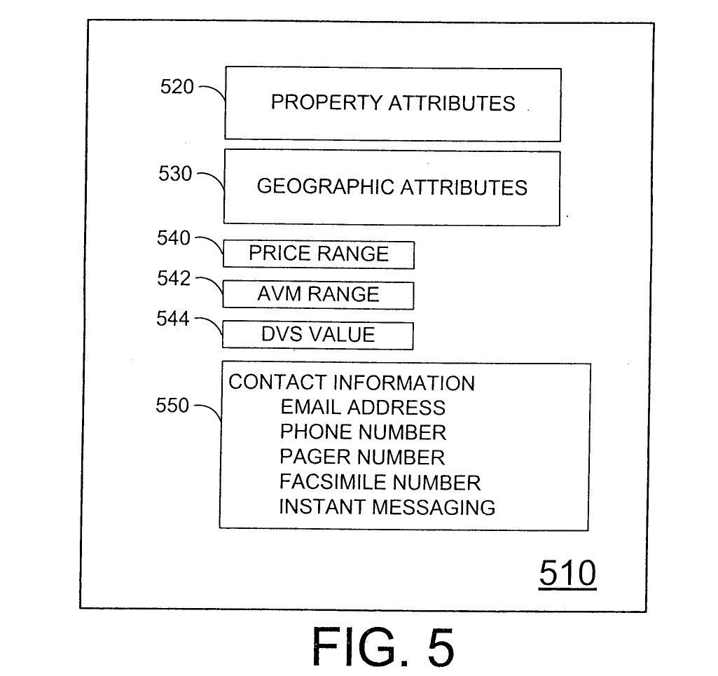

For instance, FIG. 5 depicts an exemplary visual/text-based query parameter web-page 510 that can be used by the provider 130 to gather information pertinent to a query. As shown in FIG. 5, the parameter web-page 510 can contain a number of useful entry fields 520-550, which for the immediate example can consist of any type of known or later developed entry field, such as text-entry fields, selection boxes, virtual switches, logical entry boxes and so on. A first entry field of interest is a property attribute field 520, which can enable a user to select various basic information about a property that might be of interest, such as acreage and number of bathrooms. A second entry field of interest is a geographic attribute page, which can enable a user to select geographical regions of interest down from a particular street to an entire state or possibly more, e.g., a the Southeastern portion of the United States. Other entry fields include a price range 540, an AVM range 542 and a DVS value 544.

In addition to the various query parameters accommodated by fields 520-544, the exemplary parameter web-page 510 can provide a number of contact fields 550, which can enable a software agent, e.g., the provider 130, to interact with a user in a variety of ways, including email, phone, pager, facsimile, instant messaging and so on. For example, by appropriately filling in the various contact information within the contact fields 550, the provider 130 can send initiate contact with a user via a combination of voicemail and pager signals and/or provide extensive information about a particular property via email.

Again returning to FIG. 2, as properties are identified by the query device 260 to be of interest, the query device 260 can provide the information to the display device 270. The display device 270, in turn, can provide a variety of useful displays to a terminal, such as a personal computer, to aid in the review of such properties. In a first embodiment, such a display can take the form of an ordered list, i.e., a literal display. However, even straightforward literal displays can be augmented by hyperlinks to detailed descriptions of respective properties, to maps, to driving directions, to sale histories of the property or comparable/neighboring properties etc.

In addition to literal displays, electronic and printable maps (graphic displays) of one, some or all identified properties can be generated with superimposed icons or with other identifiers representing the identified properties. Such displays can also be augmented by interactive display tools. For example, in a particular embodiment, the display device 270 can provide a “pop up” window to a terminal in order to provide information of interest. For instance, in various embodiments a user accessing the provider 130 via a PC can “click” on a property icon embedded in an electronic map displayed on his screen. In response, the display device 270 can provide a window containing useful information, such as address, sale price and AVM data.

In still other embodiments, the exemplary display device 270 can provide specialized displays and interfaces for use in mobile terminals such that the provider 130 can provide interactive driving directions, which may be especially useful for users having a GPS device integrated into their terminal. Alternatively, the display device may provide comparable audio information including addresses, driving instructions etc, or information that might be displayed on the relatively tiny displays found on many mobile phones and PDAs.

Another feature of the exemplary provider 130 is its notifier 275. The notifier 275 can operate independently or in conjunction with the display controller 270, and has the primary purpose of making quick contact with a user to alert him that important information is available, rather than provide the information itself. For example, suppose that a property comes on the market for 30% below its AVM value and has a predicted time of sale of less than 24 hours. The notifier 275 can generate a brief voice message and call the user, generate and send a fax, send a pager message and so on. In various embodiments, the notifier 275 can be programmed to send a single message or optionally be programmed to send repeated messages or messages until the user responds, in which case the provider 130 can deliver more detailed information.

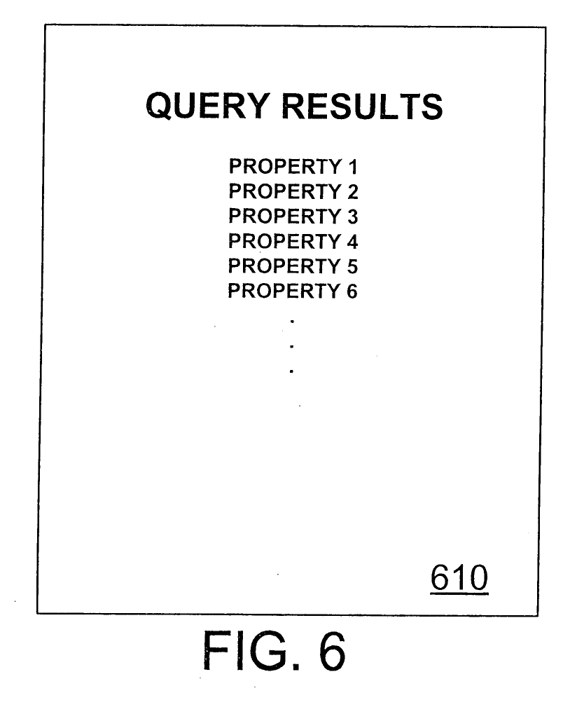

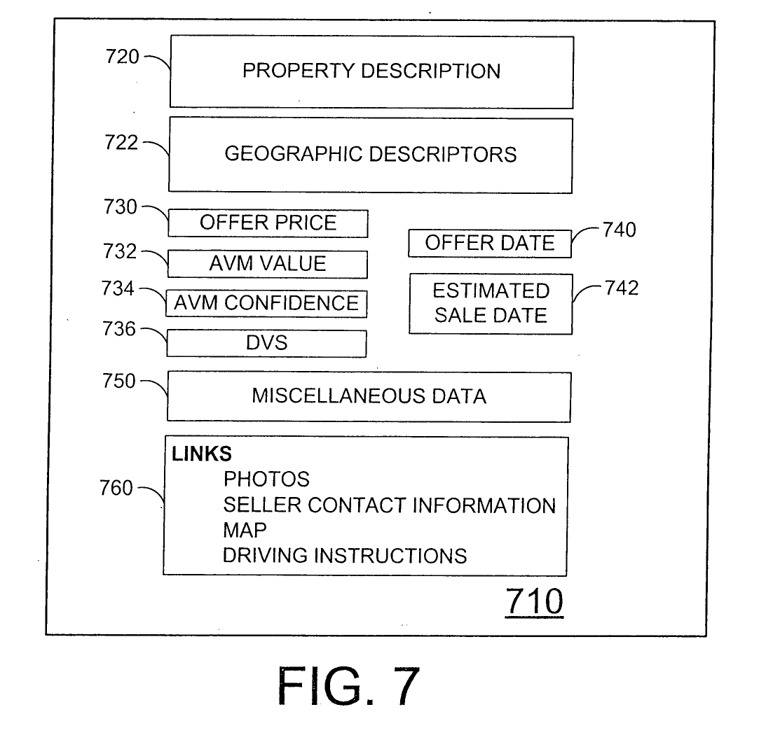

FIG. 6 depicts a first results page 610 that the provider 130 can provide either by on-line web-page, e-mail or any other adequately equipped media. As shown in FIG. 6, the first results page 610 can include a list of properties that meet criteria set by a user. For various electronic media capable of using hyperlinks or other linking technology, a user can further display details relating to individual properties. For instance, FIG. 7 depicts an exemplary second results page 710 displaying information relating to a particular property that may be evoked via electronic link or shown as an attachment to the list of FIG. 6. The exemplary second results page 710 includes a property description field 720, a list of geographic descriptors 722, e.g., county, zip code and school district, the property's offer price 730, the property's AVM value 732, the property's DVS value 736 (in percent and/or absolute dollars), the property's offer date 740 and the property's estimated date of sale 742 (explained below). Other fields of interest may include miscellaneous data 740, which might include subjective notes about the condition of the property, special concessions the seller will make etc.

In addition to the information fields 720-742 listed above, the exemplary results page 710 includes a list of links 750 leading to other useful information, including links to photos, contact information, maps and driving instructions. By activating the various links 750, a user can not only gather greater subjective data about a property, but quickly make contact with the seller and generate a map with detailed driving instructions, thus giving the user unparalleled market access.

Returning to FIG. 2, in addition to performing AVM-related (and other) queries, the provider 130 can also provide an estimate as to when a particular property is likely to sell using the predictor 265. In various embodiments, the predictor 265 can generate a sales profile of a property based on the property's AVM value, offering price, geographic location, structural details and a host of other available data using a combination of heuristic and statistical processing techniques. However, the particular processing approach and particular data used is envisioned as changing from embodiment to embodiment as technology improves or is otherwise found advantageous without departing from the spirit and scope of the present disclosure.

In addition or alternative to using AVM information, the exemplary predictor 265 can also take advantage of directly using the high-resolution spatial information provided by the spatial information device 232. That is, it should be appreciated that property sales can vary drastically along very narrow geographic boundaries or in certain patterns that low-resolution systems could never even recognize. However, using distance and possibly vector information and spatial resolutions of even a few dozen meters, sales trends can be recognized on a block-by-block basis.

The sales profile of the immediate example includes an expected sales date and a variance. However, a sales profile can alternatively take the form of charts with scattering diagrams, statistically and/or heuristically determined graphs.

Note that, like AVM values, sales prediction dates and related information can be mass processed and stored into a database, or can be generated on the fly upon a request from a user.

While much of the above-provided discussion is dedicated to providing pre-prepared AVM values—or AVM values generated otherwise without any input from the user that might affect an AVM value of a property, the disclosed methods and systems have an additional feature that allows a user to “fine-tune” AVM values.

Note that for the purpose of this discussion, requesting an AVM valuation at a particular time is specifically excluded from the concept of “input from the user that might affect an AVM value of a property”. That is, the time that an AVM request is made is not to be considered “user input” or a parameter affecting the value of an AVM valuation.

Returning to FIG. 2, once a user has received an initial AVM value for a particular property (or as an alternative to receiving an initial AVM value altogether) the user can modify a property's initial AVM value using a variety of methods.

A first method of note can be to modify a “state” of a property upon which an AVM value can depend. Such a state can refer to any intrinsic aspect of a property, such as a general condition of a property, the type of roof (tile, composite, metal etc), having a finished versus unfinished basement, any added structures (e.g., a deck, patio or pool), tile floors versus carpeting or any number of other known and/or recognizable intrinsic aspect of a property that might affect a property valuation.

A second method of note can be to correct an extrinsic aspect of the subject property, such as the proximity of the subject property to another item of interest, such as a supermarket, waterfront or highway.

A third method of note can be to correct an erroneous public record that may or may not be intrinsic to a property, such as a tax record/valuation an erroneous recording of a non-existent easement and so on.

A fourth method of note can be to modify the set of comparable properties use to derive an AVM value for a subject property. For example, assuming that for a particular subject property, the AVM device 230 of FIG. 2 recognizes twenty recently sold properties closely located to the subject properties, but pares this set of twenty down to a subset of seven properties having aspects (e.g., square feet, number of bedrooms etc) closest to the subject property. By providing a selection list of all twenty properties, the user can judiciously add to and/or remove from initially selected seven properties. The updated list of comparables can then be used to re-calculate the subject property AVM value.

While it may be beneficial to add properties as well as remove properties from a comparable property list, the inventors of the disclosed methods and systems have discovered by experimental application that limiting a user's options to removing selected comparable properties tends to better serve the non-professional consumer market. Accordingly, in various embodiments, users will only be able to remove comparable properties from consideration.

Yet another method of note can be to correct the information of a comparable property as one might do to a subject property, including both intrinsic and extrinsic information, erroneous public records and so on.

For convenience, any or all updates, either to a subject property or to a comparable property, can be saved in an account personal to the user such that the user can later retrieve this information. Information can be kept secret for the exclusive benefit of the user.

However, in various embodiments it should also be appreciated that update information can be used as a source to provide more accurate information and/or correct for errors in public records. Accordingly, in certain embodiments, user update information (as well as AVM or DVS values derived therefrom) can be “made public” for the benefit of all users with the caveat that a preliminary review of such user update information can be beneficial.

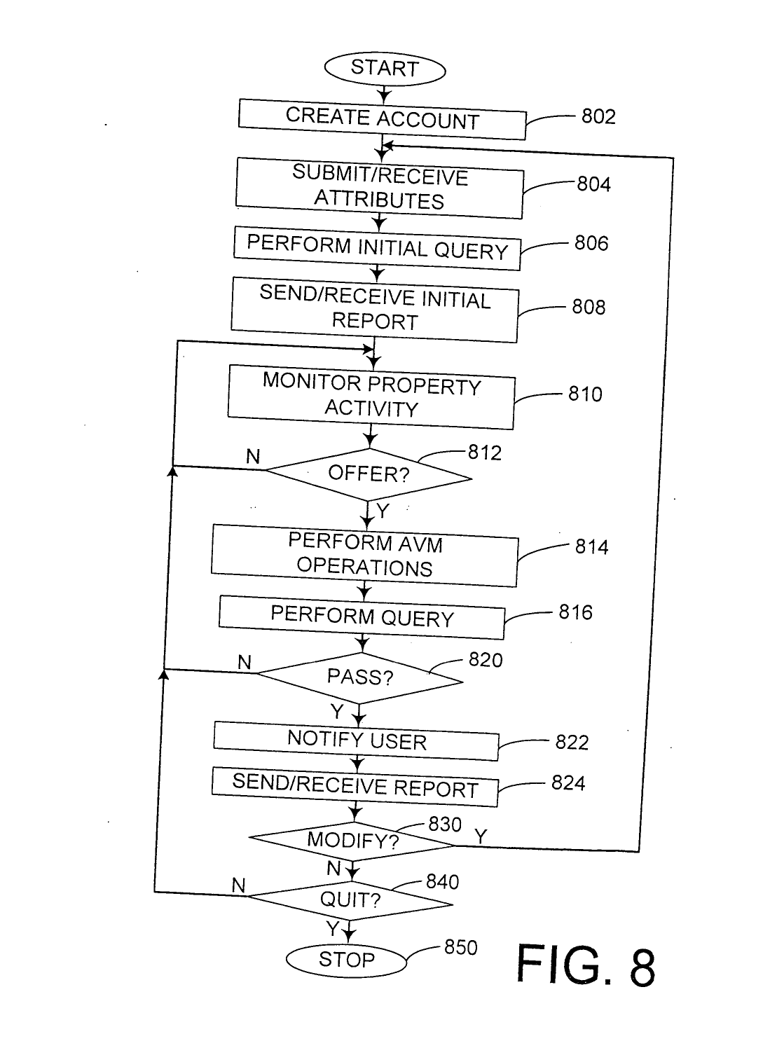

FIG. 8 is a flowchart outlining an exemplary operation according to the present disclosure for using an automated agent designed to perform AVM-related services. The process starts in step 802 where a prospective user creates an account with a computer-based agent. In various embodiments, such an agent can take the form of the provider 130 of FIGS. 1 & 2. However, the particular form of an agent can vary from embodiment to embodiment without departing from the spirit and scope of the disclosure. Next, in step 804, the user can submit a number of query parameters to the agent, including structural parameters for one or more different types of properties, geographic parameters, price and AVM ranges and so on. Once submitted the agent can receive the parameters, control continues to step 806.

In step 806, an initial query is performed using the parameters of step 804. As discussed above, such a query can involve a wide variety of parameters, such as parameters related to structural, geographic and AVM information, and effectively perform various operations, such as tasks equivalent (or substantively similar to) the DVS operations described above and the AVM-based time-to-sale prediction operations. Next, in step 808, the agent can send, and the user can receive, an initial report containing information about all properties that conform to the user's query parameters. In various embodiments, such reports can take the basic form of those reports of the various figures and text discussed above. However, it should be appreciated that the particular form and substance of the initial report can vary as required or otherwise found desirable from embodiment to embodiment. Control continues to step 810.

In step 810, the agent can monitor activity in the real estate market. Next, in step 812, a determination is made as to whether a new property is found to be for sale on the market. If a new property (or properties) is found, control continues to step 814; otherwise, control jumps back to step 810 where market activity is further monitored.

In step 814, a number of AVM operations are performed on the newly identified property to determine AVM values (and related data) in circumstances where there is no existing AVM information on the property identified in steps 810 & 812 or if existing AVM data is determined to be outdated. Using the appropriate existing, updated or newly created AVM information, control continues to step 816 where another query is performed for the newly identified property using the parameters/attributes of step 804. Control continues to step 820.

In step 820, a determination is made as to whether the property passes the query of step 816, i.e., whether the property conforms to the user's desired parameters. If the property passes the query, control continues to step 822; otherwise, control jumps back to step 810 where market activity is further monitored.

In step 822, the user is notified by the agent via any number of communication conduits identified by the user many of which are discussed above. Next, in step 824, the agent can send, and the user can receive, detailed information on the newly identified property again using any number of various communication conduits, many of which are discussed above. Control continues to step 830.

In step 830, a determination is made as to whether the user will modify his query parameters. If the parameters are to be modified, control jumps back to step 804 where the user can submit the new parameters; otherwise, control continues to step 840.

In step 840, a determination is made as to stop the agent from further monitoring the market. If monitoring is to cease, control continues to step 850 where the process stops; otherwise, control jumps back to step 810 where market activity is further monitored.

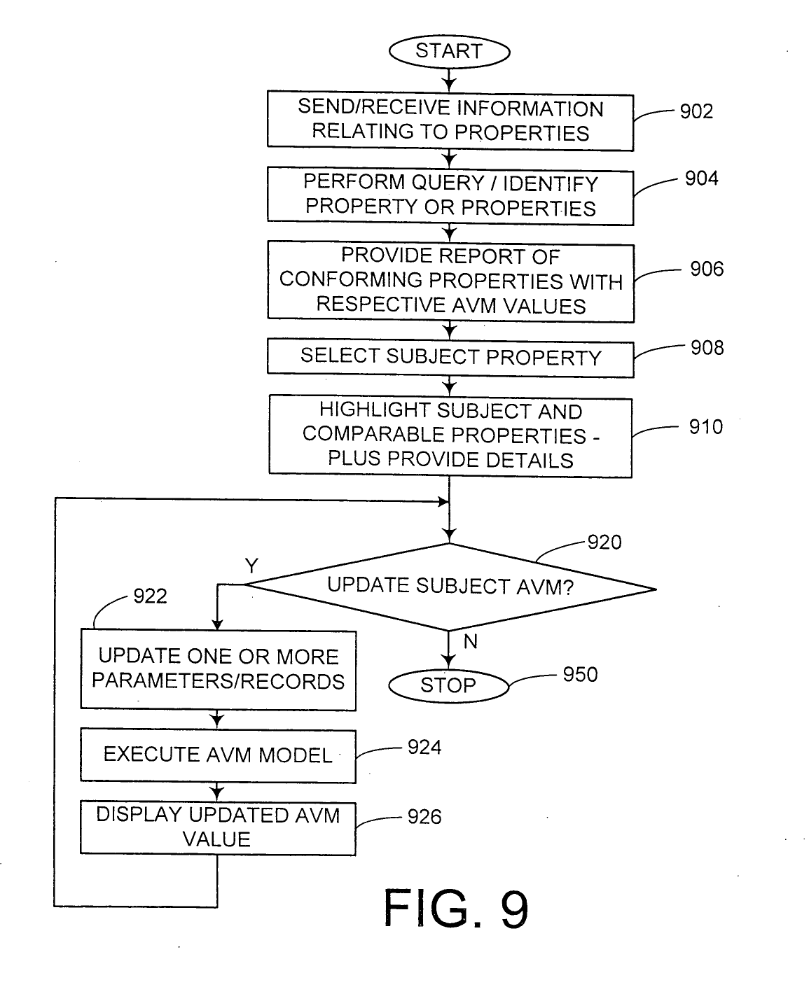

FIG. 9 is a second flowchart outlining an exemplary operation according to the present disclosure for using an automated agent designed to perform AVM-related services. The process starts in step 902 where a prospective user can send some form of search information to a computer-based device, such as the device of FIG. 2, where it can be received for further processing. As discussed above, such search information can take a variety of forms and be formed in a variety of ways, e.g., by entering in a specific address or by navigating on a map-like display and/or requesting a narrow range of AVM values. Control continues to step 904.

In step 904, a query/match can be made using the information of step 902 to identify one or more subject properties that conform to the user's parameters. Next, in step 906, a report of the conforming subject properties can be provided to the user—with each subject property having a respective initial AVM value generated—and each AVM value being generated without the user having to enter a single parameter affecting an AVM value. While the exemplary initial AVM values can be derived from a database containing AVM values prepared before the user's search even began, it should again be appreciated that AVM values might otherwise be generated “on the go” with the understanding that the processing requirements for more than a very few properties at a time can be burdensome to the point of noticeably slowing system response. For example, while a single AVM value might be generated without any noticeable subjective delay, regularly providing a dozen or so AVM values would cause noticeable 2-5 second delay—which can grow to be much larger when a large number of users are accessing the same processing resources. In contrast, the processing power required for merely accessing even hundreds of AVM values from a pre-existing database can be done with comparatively negligible delay. Control continues to step 908.

In step 908, the user can, in the course of his browsing of properties, identify a single subject property of interest that he might wish to further investigate. Next, in step 910, the computer-based device working with the user can identify/highlight the subject property on a map-like display, as well as identify/highlight a number of comparable properties used to generate the selected subject property AVM value and/or a list of prospective, but unused, comparable properties. Control continues to step 920.

In step 920, the user can take a decision as to whether to update the AVM value for the selected subject property by modifying one or more parameters used in the property's AVM valuation process. If no AVM value update is to be made, control continues to step 950 where the process stops; otherwise, control jumps to step 922.

In step 922, the user can appropriately modify any number of intrinsic and extrinsic variables concerning the subject property, as well as correct erroneous records concerning the subject property. Similarly, the user can make many or all of the same adjustments on various comparable properties, as well as add to or subtract from the list of comparable properties. Next, in step 924, the appropriate AVM valuation process can be executed using the updated information of step 922 to produce an updated AVM value. Then, in step 926, the updated AVM value can be provided to the user. Control can then jump back to step 920 where the user can optionally change the same or other parameters to create yet more updated AVM values.

While steps 902-926 are useful in providing more exact/correct marketing information for a prospective buyer, it should also be appreciated that these series of steps can be useful in allowing a seller to determine the benefit of making various changes to his property before sale. For example, using the methods and systems above a seller might determine the benefit of dividing a house having a one-acre lot into two separate half-acre lots taking into account the price reduction to the subject property on a half-acre lot compared to the added value an empty half-acre lot in a developed neighborhood.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to AVM-related services.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer-based device for performing property-related searches and providing responsive information based on information provided by a consumer at a remote terminal, the computer-based device comprising:
a communication device configured to receive selection information from the user relating to residential properties, wherein the selection information is used to identify a set of one or more properties; and
a reporting device configured to display report information to the remote terminal via a publicly or privately accessible network relating to the identified set of properties, the report information including at least a first AVM value for a first property of the identified set of properties, where the first AVM value is provided to the user without the user providing information to the computer-based device affecting the amount of the first AVM value.

2. The computer-based device of claim 1, further comprising an AVM-generating device configured such that, subsequent to the reporting device providing the first AVM value to the remote terminal, the AVM-generating device can generate a modified AVM value for the first property based on update information relating to the first property provided by the user.

3. The computer-based device of claim 2, wherein the user update information includes information relating to a physical condition of the first property.

4. The computer-based device of claim 2, wherein the user update information includes information relating to the correction of data in a public record.

5. The computer-based device of claim 2, wherein the user update information includes information relating to an addition or removal of at least a first comparable property.

6. The computer-based device of claim 5, wherein the reporting device is configured to supply a list of comparable properties used in generating the first AVM value to the remote terminal, and wherein the user update information relates to the removal of the first comparable property using the list of comparable properties.

7. The computer-based device of claim 1, wherein the reporting device is configured to also supply a list of comparable properties used in generating the first AVM value.

8. The computer-based device of claim 2, wherein the update information can be saved in an account personal to the user such that the user can later access such update information or AVM values resultant from the saved update information.

9. The computer-based device of claim 2, wherein the update information can be made available to other users of the computer-based device.

10. The computer-based device of claim 2, wherein AVM values resultant of the update information can be made available to other users of the computer-based device.

11. The computer-based device of claim 1, wherein the communication device is configured to provide a map-like graphic display of a geographic area, and the geographic area is used to define at least a portion of the selection information.

12. The computer-based device of claim 11, wherein the map-like display is configured such that the user can perform at least one of a zoom-in operation, a zoom-out operation and a panning operation.

13. The computer-based device of claim 12, wherein performing at least one of a zoom-in operation, a zoom-out operation and a panning operation redefines at least a portion of the selection information.

14. The computer-based device of claim 1, wherein the accessible network is the Internet.

15. The computer-based device of claim 1, wherein the accessible network is a private network.

16. The computer-based device of claim 1, wherein the first AVM value is provided by the computer-based device via a completely computer-generated process derived using public records.

17. The computer-based device of claim 16, wherein the first AVM value is derived from a pre-prepared database of AVM values.

18. The computer-based device of claim 16, wherein the first AVM value is derived after the reception of the received selection information.

19. The computer-based device of claim 11, wherein the selection information is made as a function of a graphic selection of the first property on the map-like display.

20. The computer-based device of claim 1, wherein the selection information is made as a function of a graphic selection of the first property from a map-like display.

21. The computer-based device of claim 1, wherein the first AVM value is calculated in response to the activation of a screen-based control.

22. A method for providing Automated Valuation Methodology (AVM) values to a consumer over a publicly or privately accessible network, the method comprising:
receiving selection information from a user at a remote terminal over the publicly or privately accessible network;
identifying a set of one or more properties using the selection information; and
reporting to the remote terminal via the publicly or privately accessible network report information that includes at least a first AVM value for a first property of the identified set of properties, where the first AVM value is provided to the user without the user providing information to the computer-based device affecting the amount of the first AVM value.

23. The method for providing AVM values to a consumer over the publicly or privately accessible network of claim 22, further comprising reporting to the remote terminal via the publicly or privately accessible network updated report information that includes an updated AVM value for the first property of the identified set of properties, where the updated AVM value is provided to the user based on user-provided information affecting the amount of the AVM value of the first property.

24. A method for enabling a consumer to receive Automated Valuation Methodology (AVM) values over a publicly or privately accessible network, the method comprising:
providing selection information from a user at a terminal to a computer-based device, wherein the computer-based device identifies a set of one or more properties using the selection information; and
receiving from the computer-based device via a publicly or privately accessible network report information that includes at least a first AVM value for a first property of the identified set of properties, where the first AVM value is provided to the user without the user providing information to the computer-based device affecting the amount of the first AVM value.

25. The method for providing AVM values to a consumer over the publicly or privately accessible network of claim 24, further comprising:
providing update information to the computer-based device affecting the amount of the AVM value of the first property using the first terminal; and
receiving from the computer-based device report information that includes an updated AVM value for the first property of the identified set of properties, wherein the updated AVM value is generated using the user-provided update information.

26. The method for providing AVM values to a consumer over the publicly or privately accessible network of claim 25, wherein the user-provided update information includes information affecting a set of comparable properties used to derive the first AVM value of the first property of the identified set of properties.

27. The method for providing AVM values to a consumer over the publicly or privately accessible network of claim 25, wherein the user-provided update information includes information relating to a physical state of the first property.
